(19) United States
(12) Patent Application Publication
(10) Pub. No.: US 2015/0032654 A1
(43) Pub. Date: Jan. 29, 2015

(54) ONLINE INTERVIEWING TECHNIQUES FOR JOB APPLICANTS

(71) Applicant: Edward W. Huff, Agusta, GA (US)

(72) Inventor: Edward W. Huff, Agusta, GA (US)

(21) Appl. No.: 14/338,662

(22) Filed: Jul. 23, 2014

Related U.S. Application Data
(60) Provisional application No. 61/858,258, filed on Jul. 25, 2013.

(51) Int. Cl. G06Q 10/10; G06F 3/0484; G06F 3/0481

(52) U.S. Cl. CPC G06Q 10/105; G06F 3/04817; G06F 3/04842
USPC 705/320

(57) ABSTRACT

A method for evaluating an applicant for a job includes transmitting applicant presentation information from a server to a computer associated with an applicant and receiving applicant response information at the server from the computer associated with the applicant. The applicant presentation information includes at least one question and a record icon. The applicant response information includes audio information recorded in response to an interaction with the record icon. The audio information is stored in the server. The method further includes transmitting administrator presentation information from the server to a computer associated with an administrator. The administrator presentation information includes information identifying the applicant, the at least one question, a play icon associated with the at least one question, and the audio information.

### CROSS REFERENCE TO RELATED APPLICATIONS

This application claims priority to U.S. Provisional Pat. Appl. No. 61/858,258, filed on Jul. 25, 2013.

### FEDERALLY SPONSORED RESEARCH OR DEVELOPMENT

[Not Applicable]

### JOINT RESEARCH AGREEMENT

[Not Applicable]

### SEQUENCE LISTING

[Not Applicable]

### BACKGROUND

The present technology relates to techniques for interviewing job applicants.

Interviewing applicants for job positions can be a difficult and time consuming task. Conducting live interviews requires the hiring entity to provide an interviewer, who may take time to prepare for the interview. Live interviews also require coordinating the schedules of both the interviewer and the applicant, which can be difficult in view of the busy schedules of the parties. Live interviews also have shortcomings in that, often, not all members of the hiring entity can be present for the live interview. Accordingly, summaries of the interview may be reported to personnel that were not present to the interview. Such summaries may not be able to capture some important details that would otherwise be gleaned from the interview. Furthermore, live interviews may not always be consistent across all applicants. For example, different interviewers may interview applicants for the same position. The applicants may be subject to more stress or more difficult questions than other applicants based on the interviewer. In these situations, live interviews may not result in the selection of the ideal candidate for the job.

Interviews may also be taken remotely (e.g., online). Such interviews may be conducted via questionnaires that are filled out by the interviewees. This method of interviewing may also be less than desirable because it fails to capture all of the benefits that can be gleaned from a live interview. When using questionnaires, applicants have unlimited time in which to think about their answers, and may be able to research answers that they would otherwise be unable to provide. Moreover, such remote interviews do not provide the hiring entity with an ability to judge the physical appearance of an applicant, the applicant's ability to speak and improvise, or the applicant's ability to react under pressure.

### SUMMARY

According to an embodiment of the present technology, a method for evaluating an applicant for a job includes transmitting applicant presentation information from a server to a computer associated with an applicant. The applicant presentation information includes at least one question and a record icon associated with the at least one question. The server then receives applicant response information from the computer associated with the applicant. The applicant response information includes audio information recorded in response to an interaction with the record icon. The server stores the audio information in at least one memory. The server then transmits administrator presentation information to a computer associated with an administrator. The administrator presentation information includes information identifying the applicant, the at least one question, a play icon associated with the at least one question, and the audio information.

The applicant presentation information may also include a request for a resume of the applicant. The applicant response information may include the resume of the applicant. The administrator presentation may include the resume of the applicant.

The server may receive administrator response information. The administrator response information may include an indication that there has been an interaction with the play icon. The server may then transmit the audio information to the computer associated with the administrator only after receiving the indication that there has been an interaction with the play icon. According to one technique, the applicant response information does not include video information.

The applicant presentation information may include timer information. The timer information may cause a countdown timer to be implemented on the computer associated with the applicant. The countdown timer may begin timing in response to the interaction with the record icon. The audio information, in this scenario, may only include information recorded during execution of the countdown timer.

The method may further include transmitting applicant presentation information to a computer associated with a first applicant and to a computer associated with a second applicant. The server may receive first applicant response information from the computer associated with the first applicant. The first applicant response information includes first audio information recorded in response to an interaction with the record icon. The server may also receive second applicant response information from the computer associated with the second applicant. The second applicant response information may include second audio information recorded in response to an interaction with the record icon. The first audio information and the second audio information is stored in the at least one memory. The server may transmit the administrator presentation information to a computer associated with an administrator. The administrator presentation information may include information identifying the first applicant, information identifying the second applicant, the at least one question, a play icon associated with the at least one question and the first applicant, a play icon associated with the at least one question and the second applicant, the first audio information, and the second audio information. The server may receive the administrator response information including an indication that there has been an interaction with the play icon associated with the at least one question and the first applicant. The server may transmit the first audio information to the computer associated with the administrator only after receiving the indication that there has been an interaction with the play icon associated with the at least one question and the first applicant. The server may receive the administrator response information including an indication that there has been an interaction with the play icon associated with the at least one question and the second applicant. The server may transmit the second audio information to the computer associated with the administrator only after receiving the indication that there has been an interaction with the play icon associated with the at least one question and the second applicant.

The applicant presentation information transmitted to the computer associated with the first applicant may include a request for a resume of the first applicant. The applicant presentation information transmitted to the computer associated with the second applicant may include a request for a resume of the second applicant. The first applicant response information may include the resume of the first applicant. The second applicant response information may include the resume of the second applicant. The resume of the first applicant and the resume of the second applicant may be stored in the at least one memory. The administrator presentation information may include the resume of the first applicant and the resume of the second applicant.

One or more of the aforementioned methods may be performed by a system for evaluating an applicant for a job. The system includes at least one processor and at least one memory including a set of instructions that, when executed by the at least one processor, cause the at least one processor to perform the aforementioned methods.

One or more of the aforementioned methods may be embodied on at least one non-transitory computer-readable medium including a set of instructions stored thereon that. The set of instructions, when executed by at least one processor, cause the at least one processor to perform the aforementioned methods.

### BRIEF DESCRIPTION OF SEVERAL VIEWS OF THE DRAWINGS

FIG. 1 provides an exemplary screenshot of an applicant login page on an online hiring platform in accordance with an embodiment of the present technology.

FIG. 2 provides an exemplary screenshot of an applicant dashboard start page in accordance with an embodiment of the present technology.

FIG. 3 provides an exemplary screenshot of another applicant dashboard start page in accordance with an embodiment of the present technology.

FIG. 4 provides an exemplary screenshot of an applicant dashboard practice session page in accordance with an embodiment of the present technology.

FIG. 5 provides another exemplary screenshot of an applicant dashboard practice session page in accordance with an embodiment of the present technology.

FIG. 6 provides an exemplary screenshot of an administrative login page for an online hiring platform in accordance with an embodiment of the present technology.

FIG. 7 provides an exemplary screenshot of an administrative dashboard welcome page in accordance with an embodiment of the present technology.

FIG. 8 provides an exemplary screenshot of an administrative dashboard manage applicant accounts page in accordance with an embodiment of the present technology.

FIG. 9 provides an exemplary screenshot of an administrative dashboard applicant file page in accordance with an embodiment of the present technology.

FIG. 10 provides an exemplary screenshot of an administrative dashboard applicant basic profile page in accordance with an embodiment of the present technology.

FIG. 11 provides an exemplary screenshot of an administrative dashboard applicant documents page in accordance with an embodiment of the present technology.

FIG. 12 provides an exemplary screenshot of another administrative dashboard applicant documents page in accordance with an embodiment of the present technology.

FIG. 13 provides an exemplary screenshot of an administrative dashboard add question page in accordance with an embodiment of the present technology.

FIG. 14 provides an exemplary screenshot of an administrative dashboard applicant question bank page in accordance with an embodiment of the present technology.

FIG. 15 provides an exemplary screenshot of an administrative dashboard applicant perspective page in accordance with an embodiment of the present technology.

FIG. 16 provides an exemplary method for screening an applicant in accordance with an embodiment of the present technology.

FIG. 17 illustrates a system for evaluating job applicants in accordance with an embodiment of the present technology.

FIG. 18 illustrates a flowchart for a method of evaluating job applicants in accordance with an embodiment of the present technology.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

The present technology relates generally to online interviewing for a job applicant. The present technology provides cloud-based software (for example, software that operates on a server) that assists in the screening process for hiring, on-boarding, training and coaching new hires. The present technology allows a potential hiring candidate (or applicant) to read a question, statement, problem, assignment and respond verbally through a computer or smart phone. The present technology records the response in a manner that can be shared with one or more administrators (for example, interviewers or evaluators). The present technology also provides functionality allowing the administrators to provide feedback on the applicants.

The present technology provides software that addresses issues with existing remote interview technologies. For example, the present technology addresses the time it takes to conduct applicant phone screening by limiting the time necessary to both schedule and conduct the phone interviews. The present technology provides various features and functionality that are particularly useful for a hiring software program. For example, the present technology provides ways to screen applicants remotely, or via a computer, without allowing the applicant to prepare responses to the questions being asked. That is, the present technology provides software that interviews applicants in a manner that can require the applicants' responses to be candid, rather than well-researched and prepared.

Additionally, the present technology provides ways to share the applicant information among individuals administrators involved in the interviewing, evaluating, hiring and/or training process. The present technology also provides a functionality that enables administrators to share feedback amongst themselves.

Previous attempts to provide software that enables online interviewing or hiring has been unsatisfactory for a number of reasons. For example, certain programs may provide recorded questions that are asked via a telephone system. In order to hear the applicants' answers to these questions, the administrative team members would call into a phone service and listen to the recorded answers. This presented problems, however, because the audio answers were not provided along with other valuable applicant information such as resumes and/or applicant assessments. That is, these programs did not provide all the desired applicant information, including audio files, video files, and printed materials (such as resumes) a not presented in a single, one-stop platform. Moreover, using a phone recording service may appear cheap and give applicants a bad first impression. Phone recording services also require administrators to complete the extra steps of looking and reviewing a complete file of an applicant.

Other previous attempts at hiring software employ video interviewing services. Video interviewing techniques can provide a solution for applicants that have already been screened and/or qualified but are remotely removed from the administrator that would need to interview them. However, video interviewing may not provide the best solution for screening and/or qualifying applicants to determine whether the hiring team should take the next step in providing the applicant with a longer, full interview. Moreover, due to the relatively large size of video files, use of video services can be a more costly approach, as it requires large amounts of digital storage capacity. Moreover, using video interviewing services provides problems where the applicants do not have access to webcams. In such a situation, the administrators may need to incur the expense of providing and shipping webcams to the applicants, which also was a costly approach. Accordingly, utilizing video interview techniques with an applicant that has not been screened can result in an inefficient use of resources.

The present technology provides systems and methods comprising various components and/or steps that can be used as a part of an applicant screening or hiring process. For example, one component of the present technology involves construction of a competency model. Certain embodiments of the present technology provide a competency model tool that facilitates building of a model for the position that is desired to be filled. The competency model tool may provide resources or applications that allow the users to rank the competencies (i.e., skills and/or qualifications) of an ideal applicant. In this manner, the present technology can develop categories of competencies, such as “must have” and “like to have” competencies, for example

Certain embodiments of the present technology may also comprise a job posting tool. For example, using the competency model as a guide, the present technology can facilitate an administrator in drafting the job posting and/or advertisement. This can be done by way of a word processing software, for example, operating in conjunction with other tools and programs that help an administrator identify certain techniques useful in a job posting.

Certain embodiments of the present technology provide a resume screening tool. In this manner, the present technology allows a user to view resumes of potential applicants in a single platform. The resume screening tool may provide a platform that allows a user to view and compare resumes of multiple applicants at once. The resume screening tool may also provide a way to view and compare certain parts of a resume across multiple applicants. For example, the resume screening tool can allow a user to view only the education level of applicants, or only the previous work experiences of certain applicants. In practice, this could be a first elimination point, for example. That is, a hiring team may eliminate certain potential applicants based on the screening of resumes.

The present technology can also comprise an assessment tool to help with the hiring and interview process. For example, the assessment tool may analyze one or more assessments, behavioral styles, and/or other applicant qualities to formulate competency scores. Certain embodiments of the present technology may also include an online interview platform. For example, the present technology may comprise an interview process loading tool that transfers applicants that have been determined most suitable for a position using one or more of the competency model tool, the job posting tool, the resume screening tool, and the assessment tool, and may load them into an online hiring platform using the interview process loading tool. For example, if the interview process loading tool may load applicants into an online hiring platform if the assessments are a match for the competency model. Once loaded into the online hiring platform, the present technology provides systems, methods and tools that provide applicants with instructions and other information, such as interview deadlines, and logon information via email, for example.

In certain embodiments of the present technology, the online hiring platform may comprise a video tool. For example, the video tool may ask the applicant to create a video recording describing why the applicant is best applicant for the position. The video tool can establish a time limit for the video recording. For example, the video tool may limit the video recording to 90 seconds. The video tool can then upload the applicant's video into the online hiring platform or to the internet via a video uploading tool, or via an internet website, such as YouTube, for example.

Certain embodiments of the online hiring platform may also comprise an audio questioning tool. For example, the online hiring platform may provide a number of questions (e.g., eight to ten questions) using the audio questioning tool. The audio questioning tool can provide questions to the applicant along with a resource for answering the questions. For example, the audio questioning tool may list a question for an applicant along with a box underneath the question. Using the audio questioning tool, the applicant can click a record icon, which will start the recording process along with a timer. Once the applicant has completed the question, or when the timer has expired, the audio answer can be uploaded into the online hiring platform. In certain embodiments the applicant is not given a second opportunity to re-record an answer. That is, there may be no opportunities for a “do-over.” In certain embodiments, the audio questioning tool may not present the question to the applicant until the applicant has pressed the record button. That is, the audio questioning tool may not provide the applicant with the question until the timer has begun to run. In this manner, the user has limited time to think and provide a candid answer to each question. A user can therefore be limited from researching and/or practicing answers to the question. This can be a useful tool for a hiring process, particularly where an applicant's ability to provide candid answers, to improvise, and to think and speak on their feet is a valuable skill for the position sought. The audio questioning tool can upload the applicant's answers to an applicant account page that can be accessed, for example, by administrators such as members of a hiring team, along with other information about the applicant.

Certain embodiments of the present technology may also comprise an applicant review tool. The applicant review tool can be accessed by computer, tablet, smart phone any time or place via a network connection or via the internet. In this manner, administrators can use the applicant review tool to access applicant information, including the applicants video recording and answers to the questions provided with the audio questioning tool. This feature allows administrators to conduct parts of the screening and hiring process at convenient times without requiring scheduled appointments. In certain embodiments, the applicant review tool allows members of a hiring team to communicate and share feedback, ideas, thoughts, and information on particular applicants as a part of the screening and hiring process. For example, the applicant review tool may provide a mechanism allowing all members of a hiring team to rank and/or rate applicants based on the video recording, the audio answers, the resume and/or other applicant information. This information can then be compiled and used to determine which applicants are most suitable for the job and/or jobs.

The present technology may also comprise a phone conversation tool. The phone conversation tool can help coordinate and arrange phone conversations with applicants. For example, after reviewing applicants using the applicant review tool, a hiring team may determine a number of applicants to advance to a telephone conversation stage. The phone conversation tool can help coordinate and schedule conversations with the applicants, for example, by sending an email to the applicants. Additionally and/or alternatively, members of the hiring team can simply reach out to the applicants directly via telephone or email.

Certain embodiments of the present technology provide an interview generator tool. The interview generator tool can help administrators generate a professional interview plan, for example, by providing behavioral interviewing questions. The interview generator tool can provide, for example, a point and click tool that creates questions based on the competency model. Using the data gathered through the screening process and the various tools of the present technology, the interview generator tool can assist administrators in planning for and conducting a quality interview.

Certain embodiments of the present technology can also provide a reference check tool. For example, the reference check tool can provide the hiring team with strategies for asking questions to an applicant's identified references that may not be anticipated.

Certain aspects can also provide an onboarding plan tool. The onboarding plan tool can help administrators develop a training plan for new employees once they have been hired to fill a certain job position. For example, the onboarding plan tool can help create a training plan and develop a method or system to provide feedback to the employee and his or her manager as to how the employee is progressing. The onboarding plan tool can be designed to operate for a specified amount of time, for example, for the first 90 days of employment. The onboarding plan tool can standardize procedures bringing new employees up to speed with a new position in an efficient manner.

In certain aspects, the onboarding plan tool can receive information from a manager or administrator. For example, a manager can upload information on a new employee for a certain position. The new employee may have certain specific tasks or assignments that are to be completed on a daily, weekly, or monthly basis, for example. When the new employee completes an assignment within a specified amount of time, the onboarding plan tool can notify the manager by generating an automatic email, for example. If the new employee does not complete an assignment on time, the onboarding plan tool can also notify the manager. In this manner there can be accountability for newly hired employees.

The manager can select tasks to be completed and load those tasks into the onboarding plan tool. In certain aspects, the tasks can be categorized as “learning” tasks, “doing” tasks, or “correcting” tasks, for example. The manager can assign a time frame for each task, for example, a manager may present an employee with a “goals program” task, which can be a document that the new employee is to fill out, and give the assign a one-week due date for the task. The new employee may therefore have one week to complete the document and upload it to a personal employee site.

The onboarding plan tool can provide resources to the employee, such as video that the employee is to watch, or a program that allows the employee to provide audio answers to questions prepared by the manager. In certain embodiments, the audio questioning tool of the present technology can be used to present questions to the employee. In this manner the employee can be trained to provide candid answers to questions that the employee can be expected while on the job. The onboarding plan tool can also include a feedback location that allows a manager to provide feedback to the employee on a particular task or assignment.

The onboarding plan tool can also include a variety of tools. For example, a drop down calendar tool to assign due dates for particular tasks. The onboarding plan tool may also comprise an assignment box allowing a user to type in a particular assignment for the employee. The onboarding plan tool may also include new hire comments section, providing a new employee with a resource to provide feedback and/or concerns about his or her experience with the new position. The onboarding plan tool can also include a video upload or playing tool, as well as an audio recording or playing tool. For example, the onboarding plan tool can utilize the audio questioning tool described herein. The onboarding plan tool can also provide a resource for documents to be uploaded by a manager and/or a new employee. The onboarding plan tool can also include a clone feature, which allows a certain plan to be cloned with new start dates so that certain data and assignments do not have to be manually repeated with respect to each new task, new employee, or new calendar term. The onboarding plan tool can also include an automated email function that lets a manager know if an employee is completing assignments by the given deadlines. The onboarding plan tool can also include a reporting tool. The reporting tool can be specific to a region or an office for example. The reporting tool can note which employees are on time or behind schedule on certain projects. In this manner, higher level executives and/or managers can view how different regions of a larger company are performing.

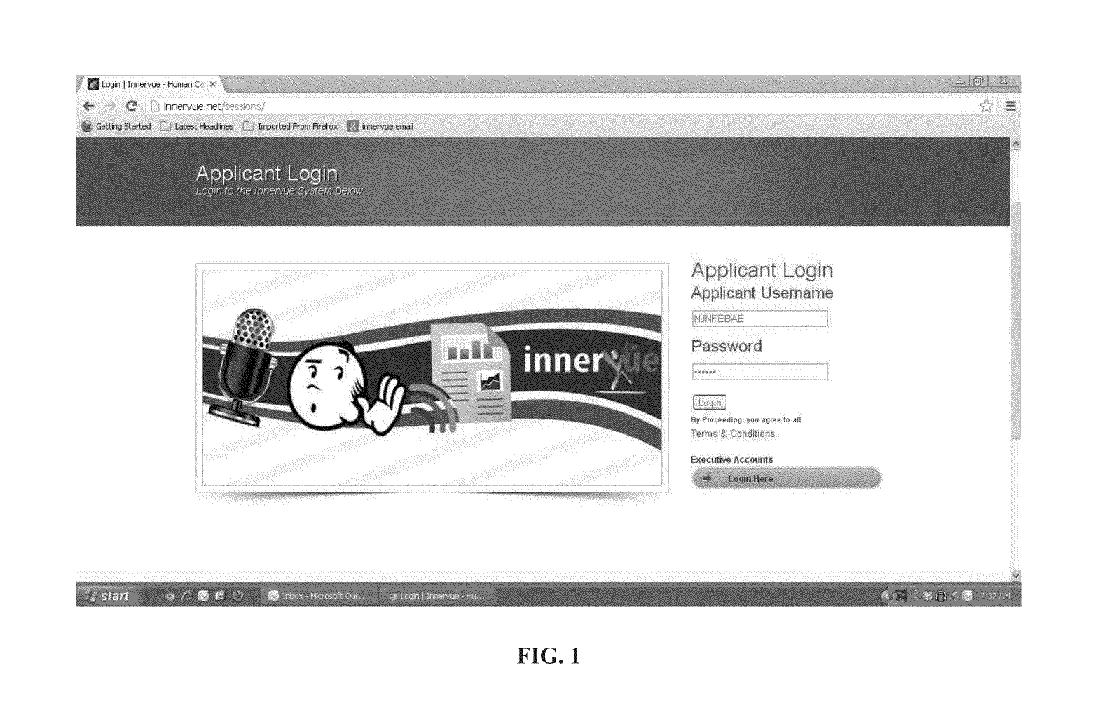

FIGS. 1-15 provide screenshots of certain aspects of an online hiring platform in accordance with the present technology. FIG. 1 provides an exemplary screenshot of an applicant login page on an online hiring platform in accordance with an embodiment of the present technology. As shown, a candidate, or applicant, can log into an applicant account using a user name and password that may have been provided to the applicant via email.

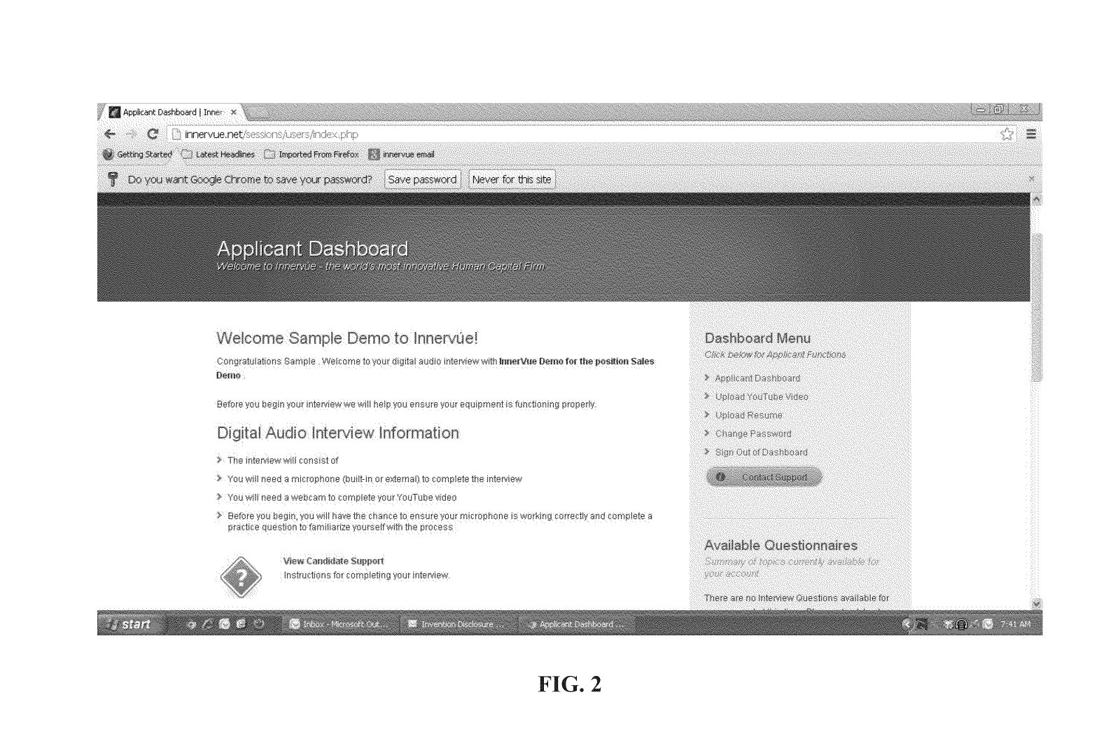

FIG. 2 provides an exemplary screenshot of an applicant dashboard start page in. At this screen, an applicant can learn information about how the online interview process will work, for example. The applicant may learn, for example, that they are only given one chance to provide a timed answer to each question, and will not be afforded an opportunity for a “do-over.”

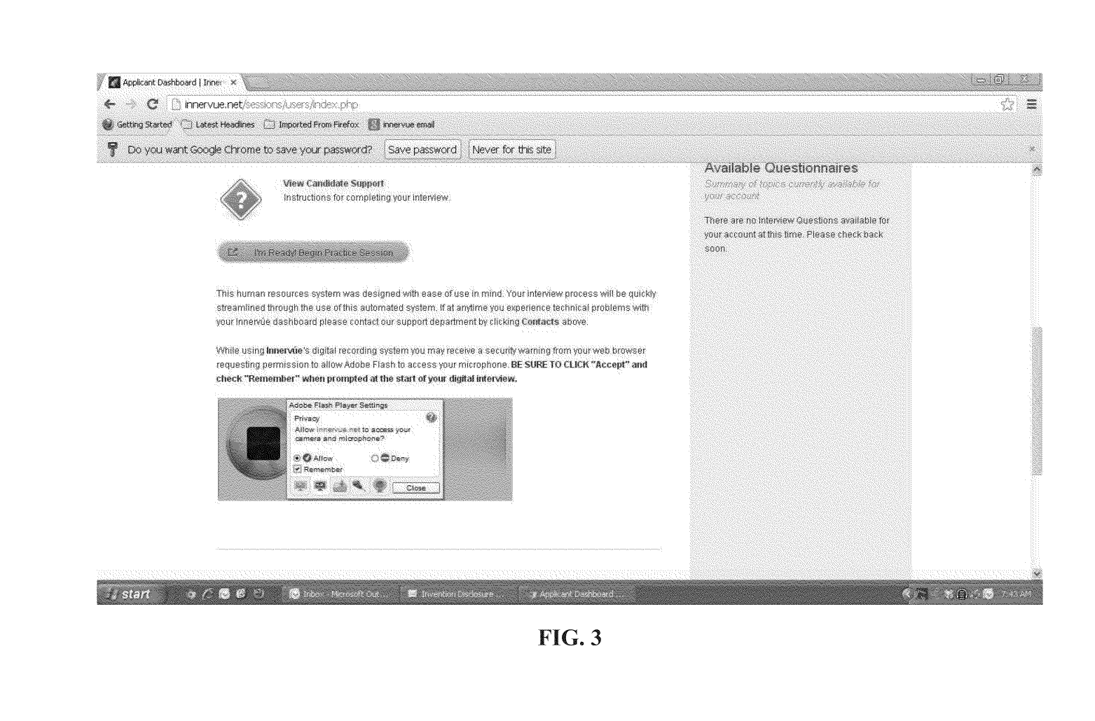

FIG. 3 provides an exemplary screenshot of another applicant dashboard start page. FIG. 3 provides a screen shot of a tool that provides a user with a chance to take a practice session. For example, the applicant may have an opportunity to answer one or more practice questions that will not be sent to the hiring team, so that the applicant can gain an understanding of the software.

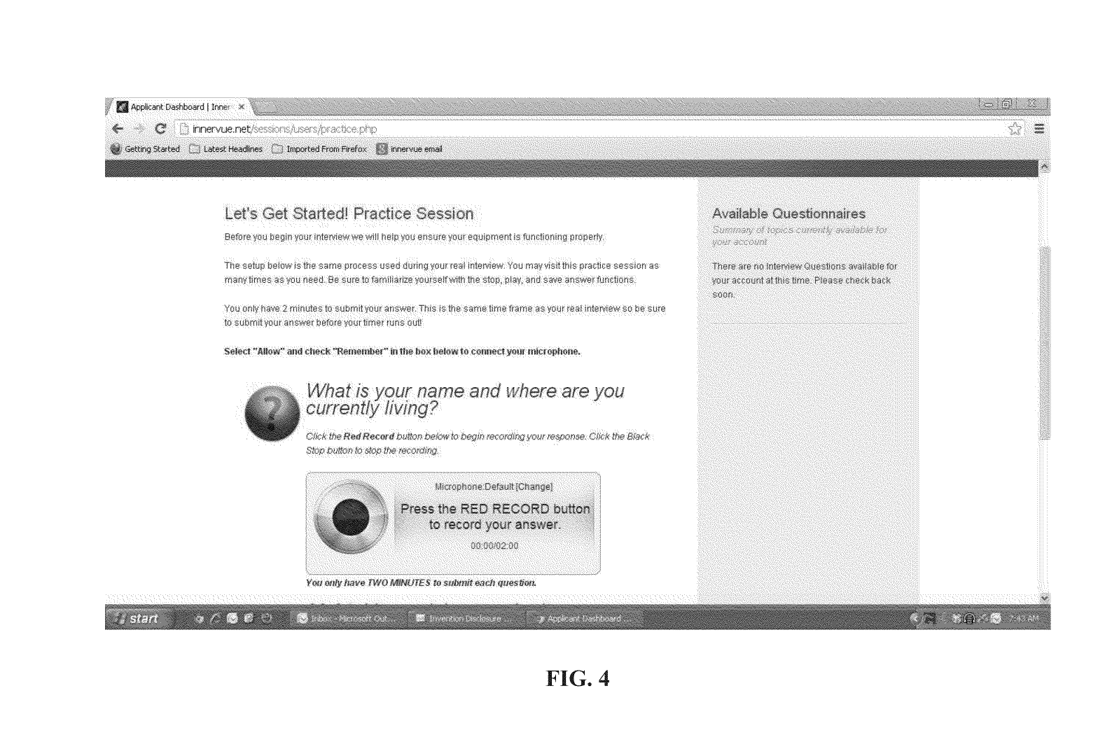

FIG. 4 provides an exemplary screenshot of an applicant dashboard practice session page. FIG. 4 depicts the audio questioning tool, which can provide, for example, a record icon for a user to click on that starts recording a user's answer, and provides a time limit for the answer.

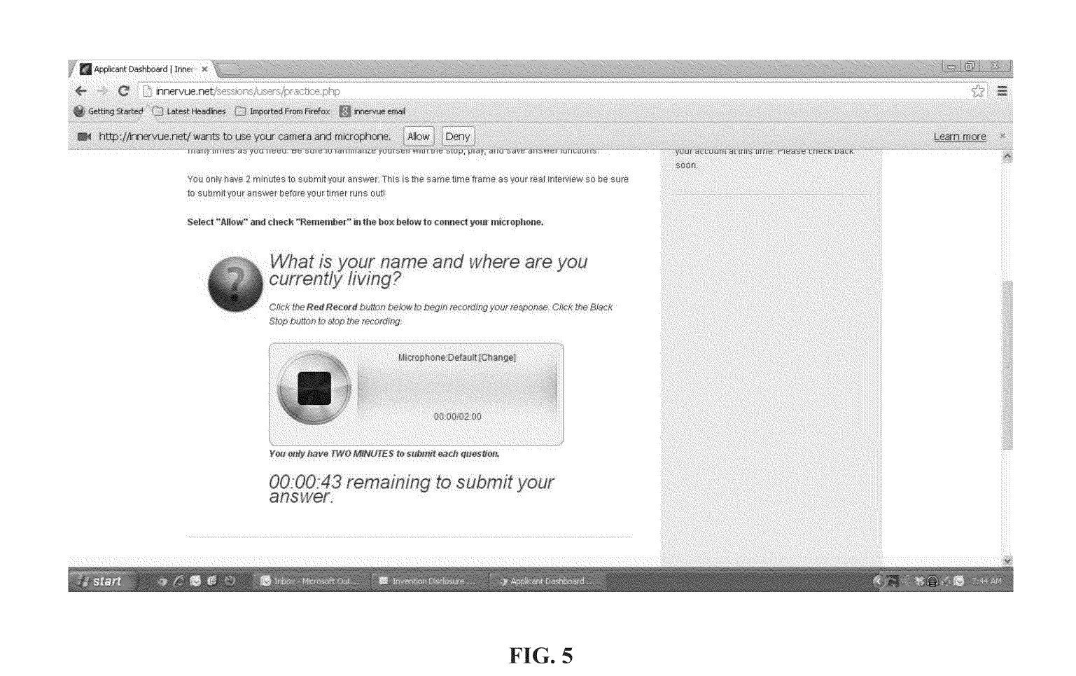

FIG. 5 provides another exemplary screenshot of an applicant dashboard practice session page. FIG. 5 provides an example of the audio questioning tool during the recording of an applicant's answer.

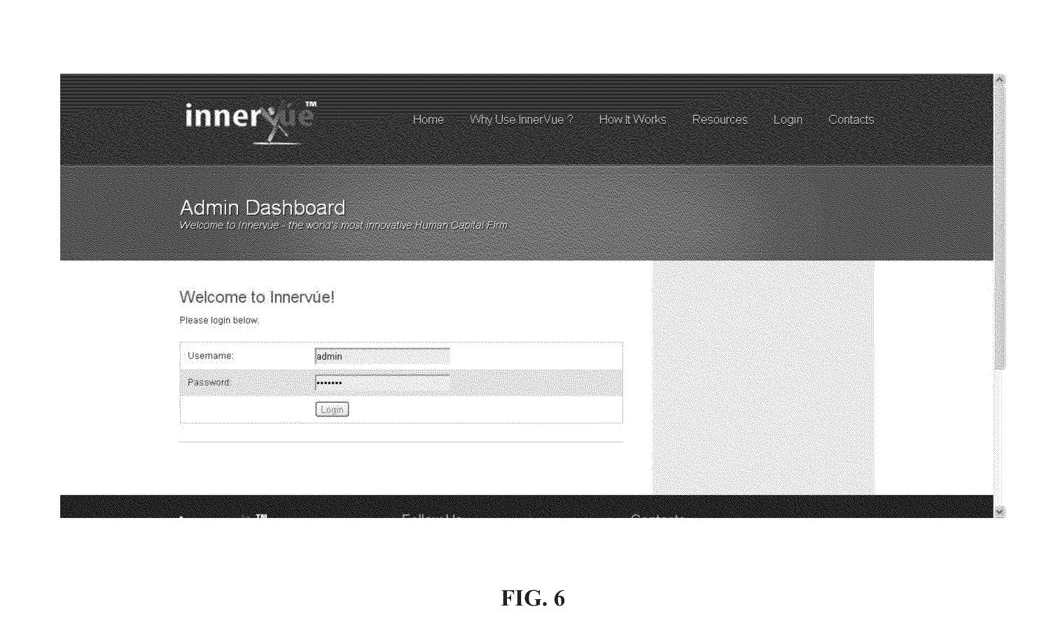

FIG. 6 provides an exemplary screenshot of an administrator's login page for an online hiring platform in accordance with an embodiment of the present technology. As shown, an administrator or member of the hiring team can log into the administrator dashboard and access information about the applicants, for example.

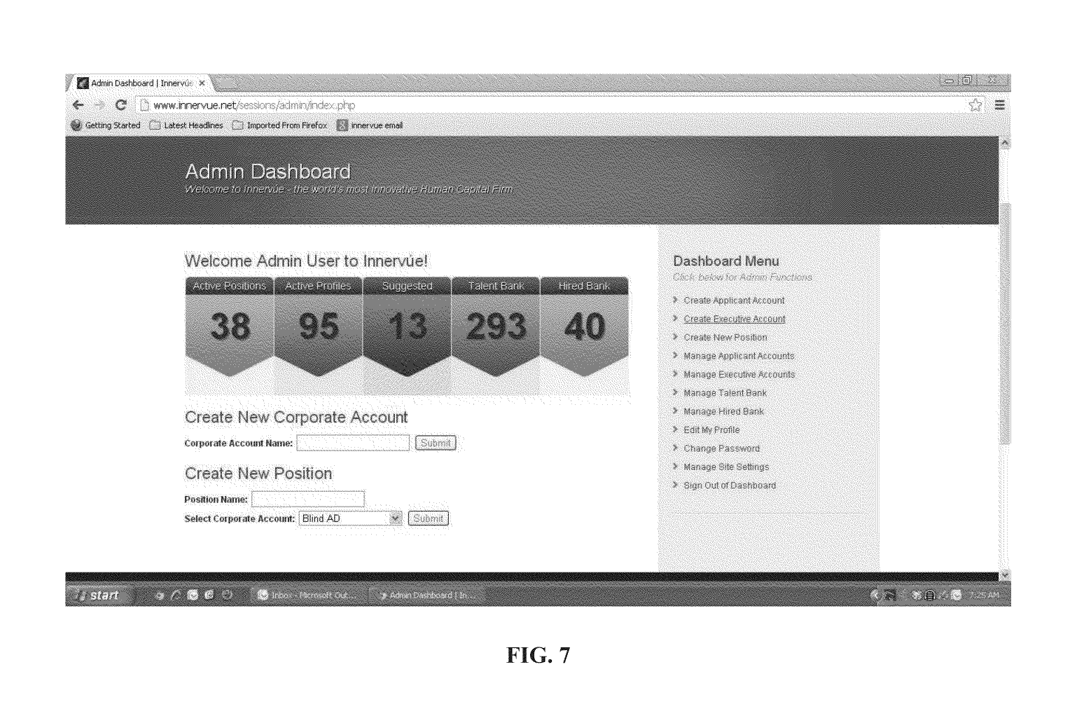

FIG. 7 provides an exemplary screenshot of an administrator dashboard welcome page. This page demonstrates the ability of a hiring team member to create corporate accounts or new job positions. This page also displays the number of active positions, active profiles, hired bank, talent bank, and suggested applicants, for example.

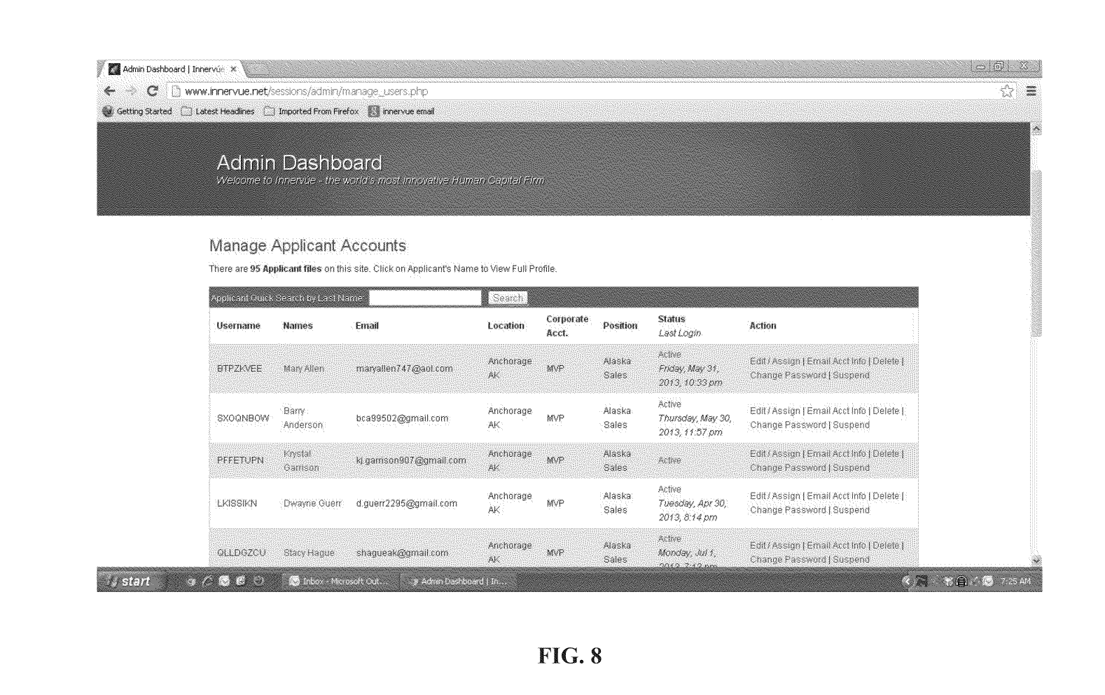

FIG. 8 provides an exemplary screenshot of an administrative dashboard manage applicant accounts page. At this page, an administrator or a hiring team member can manage various positions that are managed by the online hiring platform of the present technology.

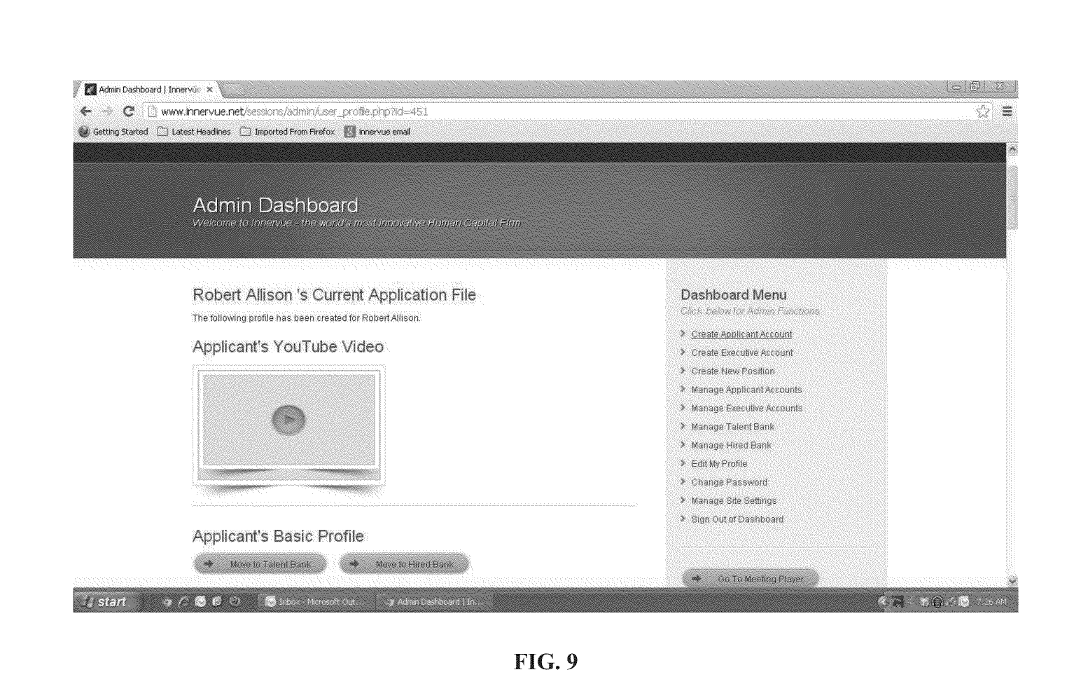

FIG. 9 provides an exemplary screenshot of an administrative dashboard applicant file page. As shown in FIG. 9, the administrator or other user can view an applicant's video recordings. For example, a user can view a video recording that has been recorded by the video recording tool of the present technology.

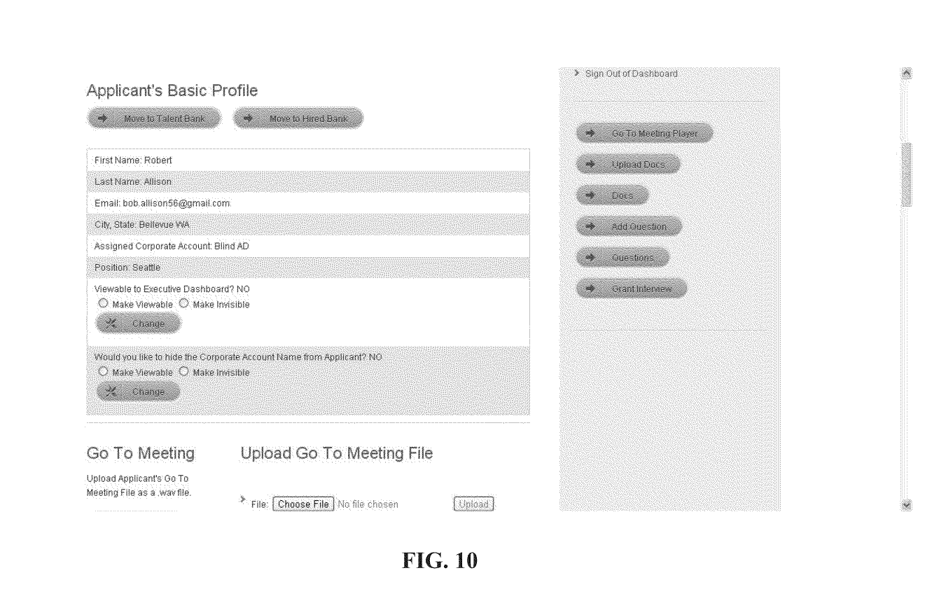

FIG. 10 provides an exemplary screenshot of an administrative dashboard applicant basic profile page. At this page, the administrator or other user is able to view basic information about an applicant, such as the applicant's name, email address and location, for example.

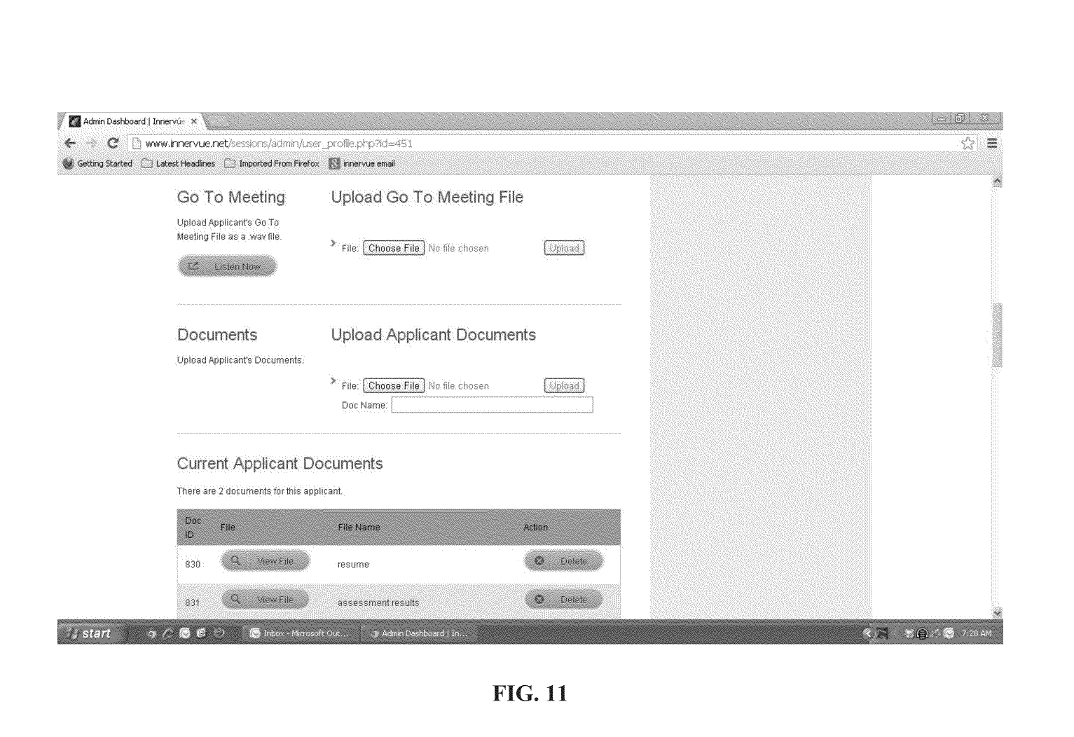

FIG. 11 provides an exemplary screenshot of an administrative dashboard applicant documents page. At this page, the user can view applicant documents such as the resume and the assessment results. For example, the administrator can view a resume using the resume screening tool, and the assessment results using the assessment tool of the present technology.

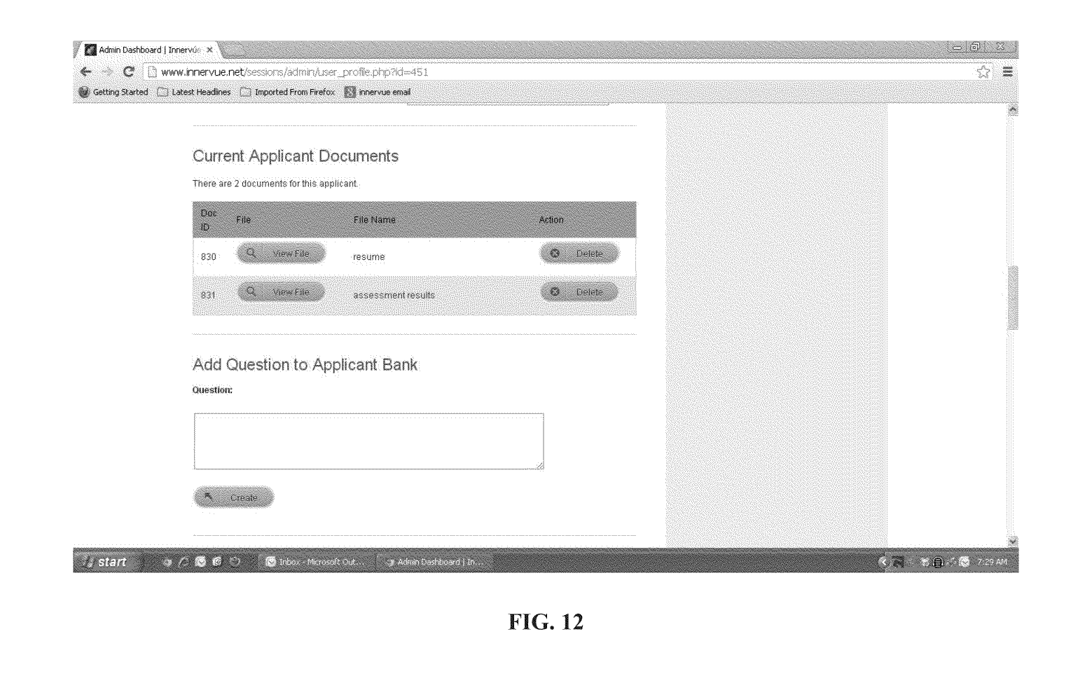

FIG. 12 provides an exemplary screenshot of another administrative dashboard applicant documents page. FIG. 12 provides a tool allowing the user to add a question to the applicant bank. For example, a user may add a question that can be provided to an applicant using the audio questioning tool.

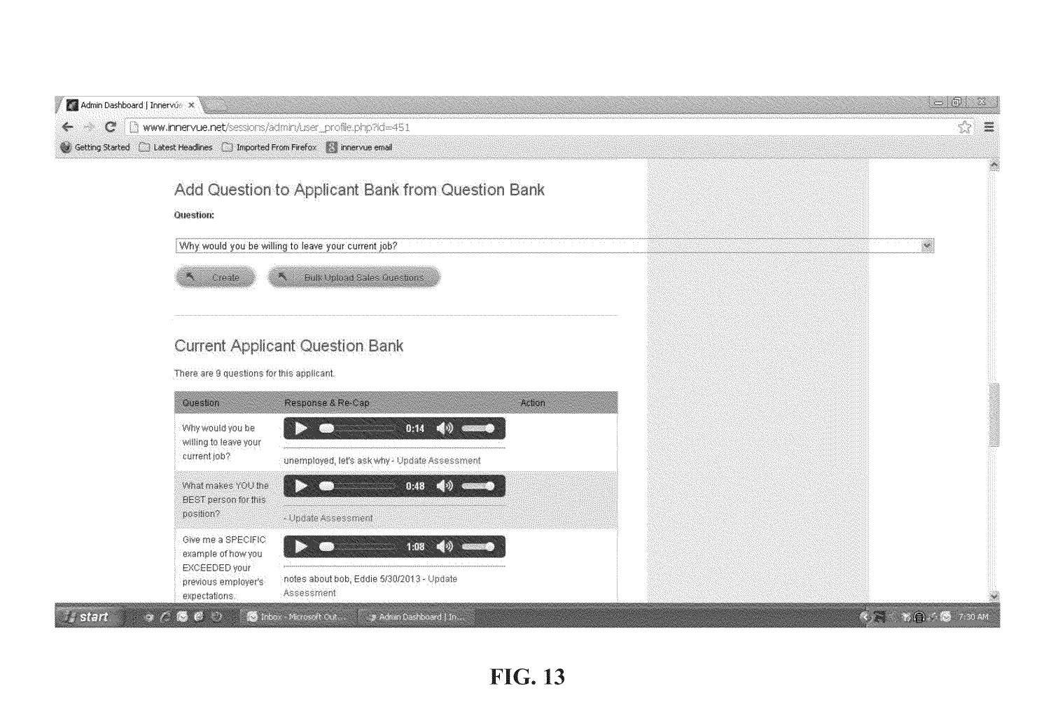

FIG. 13 provides an exemplary screenshot of an administrative dashboard add question page. As with the tool in FIG. 12, at this page, the user can add questions that can be asked of an applicant using the audio questioning tool, for example.

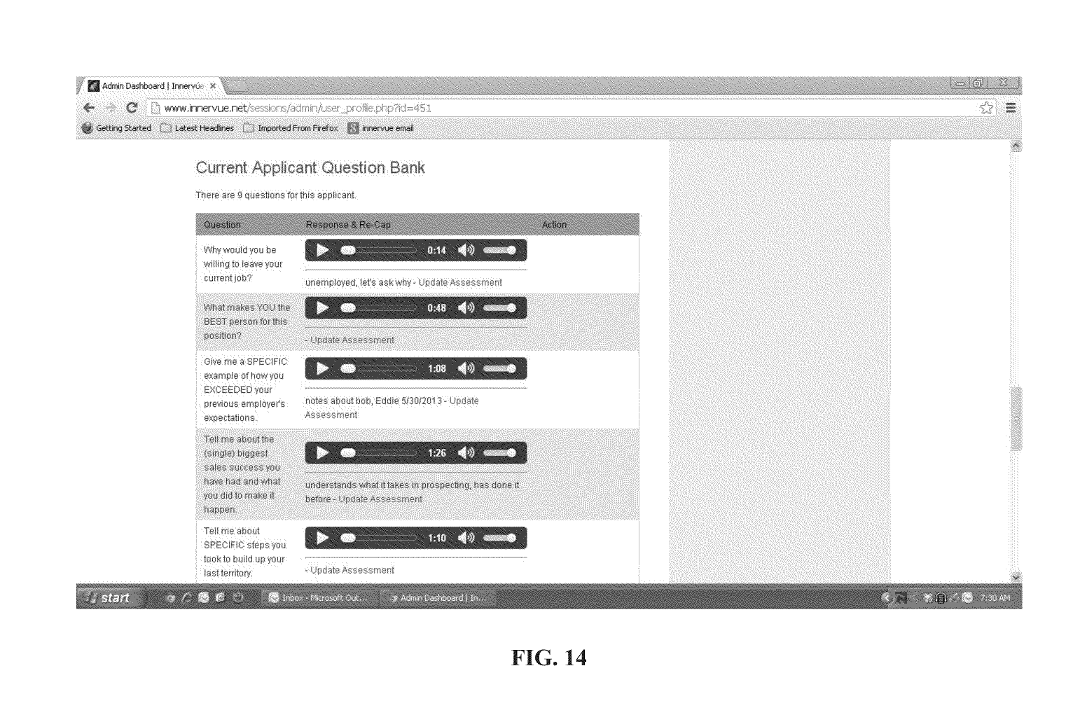

FIG. 14 provides an exemplary screenshot of an administrative dashboard applicant question bank page in accordance with an embodiment of the present technology. At this page, the user can view questions that have been provide to an applicant using the audio questioning tool, and listen to the answers that were recorded, for example. Notes may also be added and displayed in association with the question or applicant's response thereto.

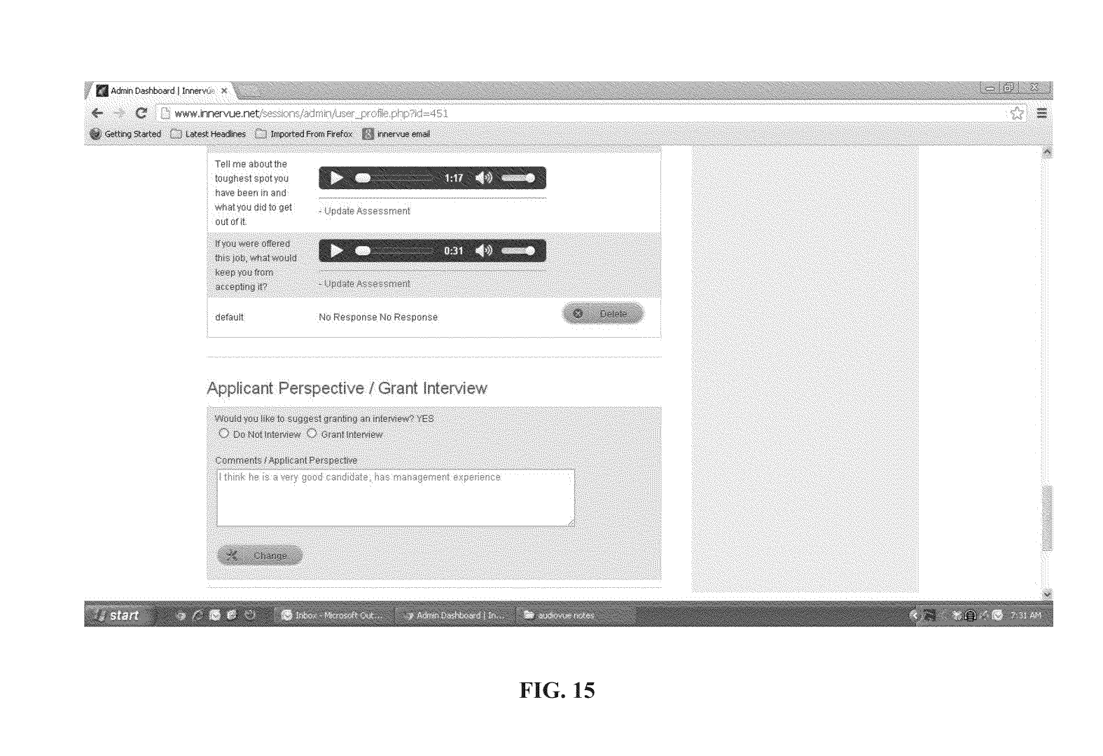

FIG. 15 provides an exemplary screenshot of an administrative dashboard applicant perspective page. At this page, the user can provide feedback to the applicant, or make a decision as to whether or not to grant an actual interview to the applicant, for example.

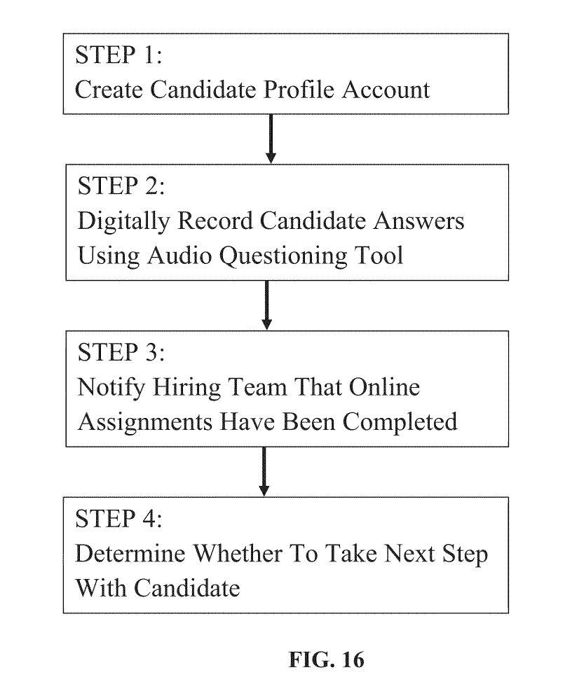

FIG. 16 provides an exemplary method for screening an applicant in accordance with an embodiment of the present technology. At step 1, the user creates a candidate (i.e., an applicant) profile account. The applicant profile account can be created, for example, based on resume. In certain embodiments, the applicants or candidates can be identified for creating a profile account by the competency model tool, the resume screening tool, and the assessment tool, for example. The applicant profile account can be filled in with the applicant name, the location of the potential hire, the title of the position applied for, and the applicant's email address, for example. The applicant's resume can also be uploaded, along with any assessment results, to the account. Questions can be populated to the applicant's account. That is, questions can be provided to ask the applicant via the audio questioning tool. The questions can be provided automatically by the software, or manually generated by a user, such as an administrator or hiring team member. The applicant can use login instructions that can be provided via email and access their account, and provide answers, videos, and other information requested by the hiring entity via a custom dashboard. The applicant can access this account and partake in the screening process without the need for special software necessary, provided that the applicant has a computer, a microphone, webcam (only if video is used), and a web browser.

At step 2, the applicant records answers using the audio questioning tool. Step 2 may involve presenting the applicant with questions via the online hiring platform, and then recording the applicant's answers using the audio questioning tool. Step 2 may also involve measuring the length of time that the applicant is recording an answer using the audio questioning tool. The applicant's responses can be limited to a certain time limit, for example, two minutes per answer. After the time limit expires, the audio questioning tool can stop recording, thereby inspiring the applicant to be efficient and candid in his or her response. The question may only be displayed while the response is being recorded.

At step 2, the applicant can also be asked to provide a video recording. For example, the applicant may be asked to provide a 90 second video explanation as to why they should be hired. This video can be uploaded to the applicant's applicant account of the online hiring platform, for example, using YouTube®. The applicant can access this account and provide the answers and videos at their own convenience. In certain embodiments, the present technology may provide a due date whereby the applicant must provide all the videos, answers and other information, for example.

At step 3, the hiring team (e.g., administrators) is notified that online assignments have been completed. Using the online hiring platform of the present technology, the hiring team can access the applicant's accounts using a computer or other mobile device, and review the audio answers, the video recordings, the applicant's resume, the applicants assessment results, and/or other documents that may have been uploaded the applicant's account. The applicant's account can be made viewable to all individuals that have input on the hire, for example, the hiring team.

At step 4, the hiring entity determines whether to take the next step with the applicant. For example, the hiring team can determine whether to bring the applicant in for a live interview, to offer the applicant a position, or to dismiss the applicant from the applicant pool. The hiring team's decision can be made on the information obtained and located within the online hiring platform, and can be assisted using the various tools of the present technology, for example, the competency model tool, the resume scanning tool, the assessment tool, the video tool, the audio questioning tool, the applicant review tool, and/or the reference check tool.

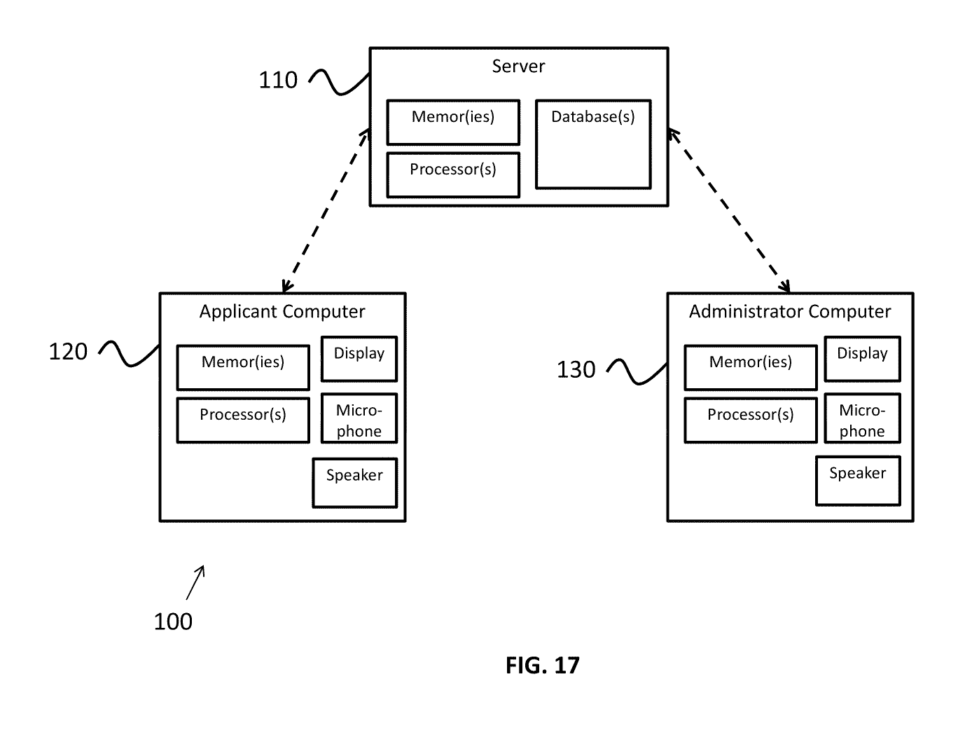

FIG. 17 illustrates a system 100 for online applicant evaluation, according to an embodiment of the present technology. The system 100 may include a server 110, an applicant computer 120, and an administrator computer 130. The system may include a plurality of applicant computers 120 and/or a plurality of administrator computers. The applicant computer 120 and the server 110 may communicate, for example, over the Internet. The administrator computer 130 and the server 110 may communicate, for example, over the Internet.

The server 110 may include one or more memories, one or more processors, and a database. The server may be one computer or a plurality of computers acting together to implement the functions described herein. The applicant computer 120 may include one or more memories, one or more processors, a display, a microphone, a speaker, and optionally a webcam. The applicant computer 120 may also include one or more user input devices (e.g., keyboard or mouse). The administrator computer 130 may include one or more memories, one or more processors, a display, and a speaker. The administrator computer 130 may also include one or more user input devices (e.g., keyboard or mouse). As used herein, a “computer” is broadly understood to include a desktop computer, a laptop, a smart phone, a personal digital assistant, a tablet, or the like. The system 100, or a portion thereof, may be capable of implementing the methods and techniques discussed herein.

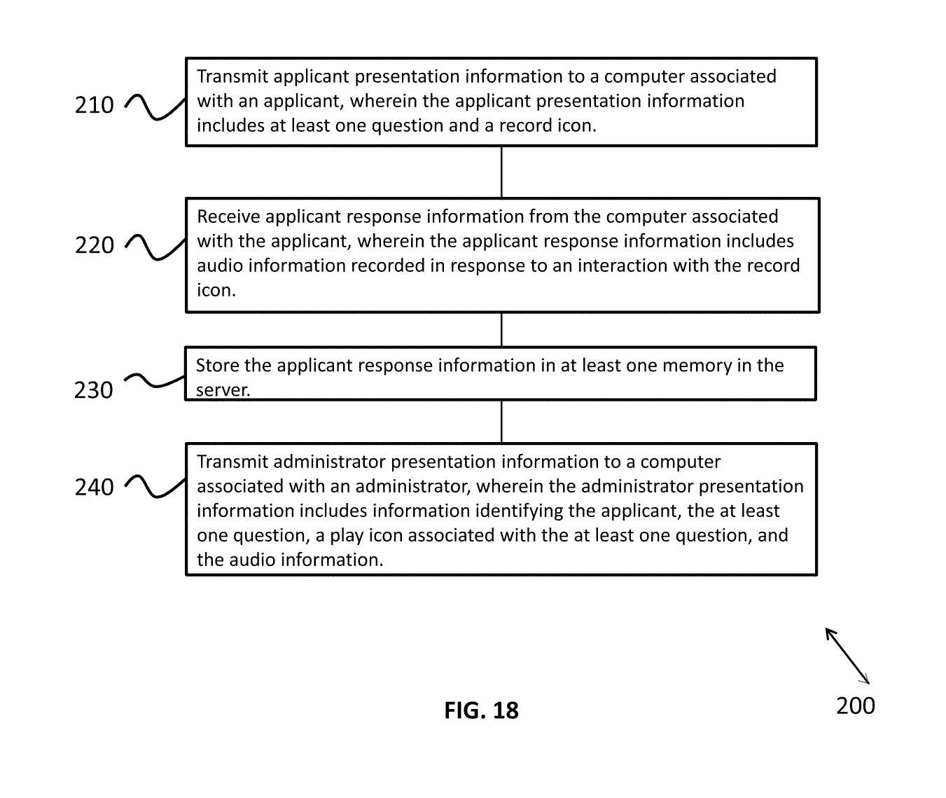

FIG. 18 depicts a flowchart 200 for a method for evaluating one or more applicants for a job, according to an embodiment of the present technology. The method may be implemented, for example, by server 110 operating in conjunction with the applicant computer 120 and the administrator computer 130 as depicted in FIG. 17. The steps illustrated in the flowchart 200, or a portion thereof, may be performable by software, hardware, and/or firmware. The steps illustrated in the flowchart 200, or a portion thereof, may also be expressible through a set of instructions stored on one or more computer-readable storage devices, such as RAM, ROM, EPROM, EEPROM, optical disk, magnetic disk, magnetic tape, and/or the like.

At step 210, applicant presentation information is transmitted from a server to a computer associated with the applicant. The applicant presentation information includes at least one question and a record icon associated with the question. The applicant presentation information may include multiple questions. The applicant presentation information may be presentable on a web browser or other software executed on the applicant computer 110. The applicant presentation information may only be transmitted if the applicant computer is authorized (for example, the applicant computer is logged on to the server).

The applicant presentation information may also include a request for documents or textual information, such as a request for a resume of the applicant. A “resume” as used herein may include any information relating to an applicant's past employment history and/or education. The applicant presentation information may include timer information that may cause a countdown timer to be implemented on the applicant computer. The countdown timer may be configured to begin timing in response to a user interaction with the record icon. According to one technique, a question may not be displayed until the countdown timer begins timing. This may ensure that the applicant gives a candid response to the question. Applicant presentation information may be transmitted to a first applicant computer and a second applicant computer.

At step 220, applicant response information is received at the server from the computer associated with the applicant. The applicant response information includes audio information recorded in response to an interaction with the record icon. The audio information may only include audio recorded during execution of the countdown timer. The applicant response information may not have video information for reasons discussed above. The applicant response information may include one or more documents, such as an image of the applicant or a resume of the applicant.

At step 230, the applicant response information is stored in at least one memory in the server. As discussed, the applicant response information may include audio information or other documents, such as a resume of the applicant. At step 240, administrator presentation information is transmitted from the server to a computer associated with an administrator. The administrator presentation information includes information identifying the applicant, the at least one question, a play icon associated with the at least one question, and the audio information. The administrator presentation may also include other documents, such as the image of the applicant or the resume of the applicant. The administrator presentation information may be transmitted at once, or at different times. For example, the server may first transmit the at least one question and the play icon. The server may then transmit the audio information only after receiving a signal from the computer associated with the administrator that there has been an interaction with the play icon.

The flowchart 200 may be repeated or adapted to accommodate a plurality of applicant computers and/or a plurality of administrator computers. The following example is illustrative of this scenario. Assume there are two applicants (a first applicant and a second applicant) who are applying for a job. There are also two administrators (a first administrator and a second administrator) who are both tasked with evaluating each of the applicants. Each party has a computer that communicates with a server. The computers use a web browser as a client, although other types of client software could be used.

Initially, the computers of the applicants and the administrators each require login information (for example, username and password) to fully communicate with the server. Each party registers to use the software, and they are provided with appropriate login credentials. Each party provides correct login credentials. The server then recognizes the computers of each party as valid clients (although the clients of the administrators and the applicants may differ).

Each applicant is asked the same questions, which are associated with the job. For the sake of brevity, only two questions are used in this example. The first question is, “Why would you be willing to leave your current job?” The second question is, “Why are you qualified for the new position?” The server sends the questions, a record icon, and countdown timer information to each applicant computer. The countdown timer duration for the first question is 2 minutes. The countdown timer for the second question is 3 minutes.

Through the client, the first applicant is prompted for, and responsively uploads his resume. The resume is transmitted by the first applicant's computer and is received by the server and stored in the server's memory. The client then prompts the first applicant to begin an audio interview session. The client instructs the first applicant to start recording an answer to the first question. The first applicant then interacts with the record icon by clicking on it. The first question is displayed and the 2-minute countdown timer starts executing. While the countdown timer is executing, the first applicant provides his response to the first question as audio information recorded through a microphone associated with the computer (for example, a built-in microphone). When his response is finished, the first applicant indicates so by clicking on the record icon again (although other ways of stopping could also be provided, such as a stop icon). The response to the first question is sent as an audio file to the server, where it is stored in memory.

The client instructs the first applicant to start recording an answer to the second question. The first applicant then interacts with the record icon by clicking on it. The second question is displayed and the 3-minute countdown timer starts executing. While the countdown timer is executing, the first applicant provides his response to the second question as audio information recorded through a microphone associated with the computer (for example, a built-in microphone). The countdown timer expires before the first applicant could finish his response. Only the portion of the first applicant's response that was recording during execution of the 3-minute countdown timer is sent as an audio file to the server, where it is stored in memory. Now the first applicant's online interview is complete.

Through the client, the second applicant is prompted for, and responsively uploads her resume. The resume is transmitted by the second applicant's computer and is received by the server and stored in the server's memory. The client then prompts the second applicant to begin an audio interview session. The client instructs the second applicant to start recording an answer to the first question. The second applicant then interacts with the record icon by clicking on it. The second question is displayed and the 2-minute countdown timer starts executing. While the countdown timer is executing, the second applicant provides her response to the first question as audio information recorded through a microphone associated with the computer (for example, a built-in microphone). When her response is finished, the second applicant indicates so by clicking on the record icon again (although other ways of stopping could also be provided, such as a stop icon). The response to the first question is sent as an audio file to the server, where it is stored in memory.

The client instructs the second applicant to start recording an answer to the second question. The second applicant then interacts with the record icon by clicking on it. The second question is displayed and the 3-minute countdown timer starts executing. While the countdown timer is executing, the second applicant provides her response to the second question as audio information recorded through a microphone associated with the computer (for example, a built-in microphone). The countdown timer expires before the second applicant could finish her response. Only the portion of the second applicant's response that was recording during execution of the 3-minute countdown timer is sent as an audio file to the server, where it is stored in memory. Now the second applicant's online interview is complete.

The server transmits the questions, the identities of the applicants, and play icons associated with each question (one play icon may be transmitted and it may be separately associated with each question) to each administrator computer. The first administrator interacts with his client to access the resume of each applicant. Upon interaction, the client requests the resumes from the server, and the server retrieves them from memory and sends them back to the computer of the first administrator.

The first administrator then clicks the play icon for the first applicant's answer to the first question. Upon interaction, the client requests the first audio information, and the server retrieves it from memory and sends it back to the computer of the first administrator. The computer of the first administrator then plays back the first applicant's answer to the first question. This process is repeated for the first applicant's response to the second question, the second applicant's response to the first question, and the second applicant's response to the second question. Thus, the first administrator listens to each applicant's response to each question. The first administrator provides comments through the client for each answer. These comments are transmitted to the server where they are stored in memory.

The second administrator interacts with her client to access the resume of each applicant. Upon interaction, the client requests the resumes from the server, and the server retrieves them from memory and sends them back to the computer of the second administrator.

The second administrator then clicks the play icon for the first applicant's answer to the first question. Upon interaction, the client requests the first audio information, and the server retrieves it from memory and sends it back to the computer of the second administrator. The computer of the second administrator then plays back the first applicant's answer to the first question. This process is repeated for the first applicant's response to the second question, the second applicant's response to the first question, and the second applicant's response to the second question. Thus, the second administrator listens to each applicant's response to each question. The second administrator provides comments through the client for each answer. These comments are transmitted to the server where they are stored in memory. The second administrator also requests, through the client, to see the comments of the other administrators (in this case, the first administrator). The server retrieves these comments from memory and transmits them to the computer of the second administrator. The comments are then displayed on her client in association with a corresponding question—that is, the first administrator's comment with respect to the first applicant's response to the first question is displayed in association with the first question, etc.

Aspects of the techniques described herein may be implemented in digital electronic circuitry, computer software, firmware, or hardware, including the structures disclosed herein and their structural equivalents, or in various combinations. Aspects of the techniques described herein may be implemented as one or more computer programs, for example, one or more sets of program instructions residing on or encoded in a computer-readable storage medium for execution by, or to control the operation of, one or more processors. Alternatively or in addition, the instructions may be encoded on an artificially-generated propagated signal, for example, a machine-generated electrical, optical, or electromagnetic signal that may be generated to encode information for transmission to a suitable receiver apparatus for execution by one or more processors. A computer-readable medium may be, or be included in, a computer-readable storage device, a computer-readable storage substrate, a random or serial access memory array or device, various combinations thereof. Moreover, while a computer-readable medium may or may not be a propagated signal, a computer-readable medium may be a source or destination of program instructions encoded in an artificially-generated propagated signal. The computer-readable medium may also be, or be included in, one or more separate physical components or media (for example, CDs, disks, or other storage devices).

Certain techniques described in this specification may be implemented as operations performed by one or more processors on data stored on one or more computer-readable mediums or received from other sources. The term “processor” may encompass various kinds of apparatuses, devices, or machines for processing data, including by way of example a central processing unit, a microprocessor, a microcontroller, a digital-signal processor, programmable processor, a computer, a system on a chip, or various combinations thereof. The processor may include special purpose logic circuitry, for example, a field programmable gate array or an application-specific integrated circuit.

Program instructions (for example, a program, software, software application, script, or code) may be written in various programming languages, including compiled or interpreted languages, declarative or procedural languages, and may be deployed in various forms, for example as a stand-alone program or as a module, component, subroutine, object, or other unit suitable for use in a computing environment. Program instructions may correspond to a file in a file system. Program instructions may be stored in a portion of a file that holds other programs or data (for example, one or more scripts stored in a markup language document), in a dedicated file or in multiple coordinated files (for example, files that store one or more modules, sub-programs, or portions of code). Program instructions may be deployed to be executed on one or more processors located at one site or distributed across multiple sites connected by a network.

Certain aspects of the present technology provide a computer software platform that: (1) allows an applicant to read a question on their computer or smart phone; (2) allows an applicant to answer the question verbally so we could hear their tonality; (3) seeks candid answers, i.e., the applicant does not know what question will be coming, and therefore does not have time to prepare a response or thought process in advance; (4) provides a timer for the applicant to see while answering questions; (5) is capable of preventing an applicant from re-answering a question (i.e., no “do-overs”); (6) provides easy access to recordings for multiple people involved in the hiring decision; (7) provides inputs so that so that individuals involved can provide comments and other feedback; and/or (8) can automate a process by delivering automated emails to applicants that provide instructions and a deadline.

Certain embodiments of the present technology provide a website that allows applicants to access the online hiring platform. For example, a link can be posted on a hiring company's website and/or social media pages that direct applicants to the online hiring platform of the present technology. The online hiring platform allows an applicant to self-register, and an email can be automatically sent to the applicant's inbox. Additionally and/or alternatively, applicants can be loaded into the system by an administrator (e.g., name, email, city, position can be entered for each applicant) and an email can then be automatically sent to the respective applicant. Certain aspects of the present technology can generate an automatic email to a hiring manager or other member of a hiring team when an applicant has registered and/or completed an assignment.

The present technology may provide a question database that comprises a bank of questions that are suitable to provide to applicants via the audio questioning program. An administrator can select one or more questions from the question database, or generate one or more questions that are not from the database to present to applicants. Additionally and/or alternatively, the administrator can generate modified questions that incorporate one or more questions from the question database in a modified format. In certain embodiments, users can provide a group of questions for a certain position and upload those as a “bulk upload.” For example, a hiring team may desire to present all sales positions with a “bulk upload” that comprises at least one or more questions that are identical across all applicants. Sample question that could be provided to applicants include, for example “Why would you be willing to leave your current job?”

In certain aspects, if an applicant does not provide or submit an answer, the answer can be voided and appear in the administrator (or hiring team's) tool (or dashboard) as an ignored, or incomplete answer.

In certain aspects, after an applicant submits one answer, the next question can appear immediately. In alternative embodiments, the applicant may be able to ask for the next question by clicking a button, for example.

The present technology provides a tool that allows applicants, that is, people being interviewed, trained, and coached, an opportunity to record an answer to a candid question, with a time limit, that can be shared with others. The present technology also provides mechanisms that allow the hiring team to provide feedback to the applicants, and in certain embodiments, allows the applicants to provide feedback to the hiring team.

The present technology provides systems and methods that facilitate the recording of a response to a candid question. In certain aspects, the present technology can provide a timer that limits the amount of time an applicant has to answer a particular question. The timer can be adjusted such that the hiring team can provide more time for certain questions. Certain aspects of the present technology can also provide a place holder for responses or feedback to either the person doing the exercise or the team involved in hiring/training. The present technology can be implemented as a part of an overall screening/hiring/training component, thereby providing a time saving solution to the hiring process.

The present technology reduces the amount of time a hiring team may need to spend on a screening process. That is, the present technology reduces the amount of time it takes a hiring committee to determine which applicants to offer full, live interviews, for example. For example, the present technology reduces and/or eliminates the amount of time needed to be spent on conducting screens, making multiple phone calls, listening to voice mails or reading and following up on emails as a part of the screening process. Further, the present technology allows applicants to perform their part of the screening process at a time of their convenience, without needing to coordinate schedules, which could require applicants to take time off of work, or arrange for babysitters, for example. The present technology also provides access to the applicants answers and profiles to all members of a hiring team, and can also provide resources to facilitate collaboration among the hiring team.

There is a large incentive for companies to find the ideal employees for their job openings. Accordingly, there can be many benefits, including cost savings, in finding and hiring the ideal applicant. It can be difficult to find the proper questions to ask in order to determine if an applicant possesses the competencies needed to be useful a particular position. The present technology provides techniques that can make an applicant answer the right questions. The present technology can take negative qualities such as laziness, fear, and lack of knowledge out of the hands of a poor interviewer.

Certain embodiments of the present technology provide an online hiring platform for screening applicants as a part of a hiring process. In certain aspects, the online hiring platform comprises a graphical user interface providing applicant and administrator access to the online hiring platform. Certain aspects also comprise an audio questioning tool that presents questions to an applicant and records audio answers from the applicant via an audio recording tool. Certain aspects also provide an applicant review tool that provides administrator access to the audio answers via the graphical user interface. The audio questioning tool can control applicant access to the audio recording tool. In certain embodiments the graphical user interface comprises an applicant dashboard interface that provides applicants access to the online hiring platform, and an administrator dashboard interface that provides administrators access to the online hiring platform, for example.

Certain aspects of the present technology provide an online hiring platform for screening applicants as a part of a hiring process. The online hiring platform may comprise, for example, a graphical user interface providing applicant and administrator access to the online hiring platform. The online hiring platform may also comprise a competency model tool that develops a model of desired employee competencies for a job position. Certain aspects also provide a resume screening tool providing administrator access to applicant resumes stored in a resume database. The present technology may also comprise an audio questioning tool that presents questions to an applicant and records audio answers from the applicant via an audio recording tool, the audio questioning tool controlling applicant access to the audio recording tool. In certain embodiments, the present technology may comprise an assessment tool that analyzes applicant competencies, and an applicant review tool that provides administrator control of, and access to the competency model tool, the resume screening tool, the audio questioning tool, and the assessment tool, via the graphical user interface. The assessment tool can present the administrator with an assessment of applicants applying for a job position. In certain embodiments, the online hiring platform may also comprise a job posting tool that facilitates the drafting of a job posting for a job position, a video tool that records applicant videos, and a reference check tool that provides strategies for asking questions to applicant references. Certain aspects may also comprise an onboarding plan tool that develops training plans for applicants that have been hired to fill a job position. Certain aspects of the present technology may also provide a question database comprising a store of questions, wherein the audio questioning tool presents questions from the question database to applicants.

Certain embodiments of the present technology provide methods of screening applicants as a part of a hiring process. The method may comprising the steps of creating an applicant profile account using an online hiring application on a computer. The method may also involve obtaining applicant answers using an audio questioning tool. The recording step can include, for example, presenting a question to an applicant via an online hiring platform, digitally recording an audio applicant answer to the question using an audio questioning tool, and measuring the length of time that the applicant is recording an answer to the question. The method may also include notifying a hiring team when the obtaining applicant answers step has been completed, for example, by automatically sending an email to one or more members of the hiring team. In certain embodiments, the audio questioning tool prevents the applicant from recording answers to a question after the measured length of time has exceeded a preset value, and wherein the audio questioning tool prevents an applicant from recording a second answer to any single question.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A method for evaluating an applicant for a job, wherein the method comprises:
transmitting applicant presentation information from a server to a computer associated with an applicant, wherein the applicant presentation information includes at least one question and a record icon associated with the at least one question;
receiving applicant response information at the server from the computer associated with the applicant, wherein the applicant response information includes audio information recorded in response to an interaction with the record icon;
storing the audio information in at least one memory in the server;
transmitting administrator presentation information from the server to a computer associated with an administrator, wherein the administrator presentation information includes information identifying the applicant, the at least one question, a play icon associated with the at least one question, and the audio information.

2. The method of claim 1, wherein:
the applicant presentation information includes a request for a resume of the applicant;
the applicant response information includes the resume of the applicant;
the resume of the applicant is stored in the at least one memory; and
the administrator presentation information includes the resume of the applicant.

3. The method of claim 1, wherein the applicant response information does not include video information.

4. The method of claim 1, wherein:
the applicant presentation information includes timer information;
the timer information causes a countdown timer to be implemented on the computer associated with the applicant;
the countdown timer begins timing in response to the interaction with the record icon; and
the audio information only includes information recorded during execution of the countdown timer.

5. The method of claim 4, wherein a selected one of the at least one question is caused to be displayed on the computer associated with the applicant only after the countdown timer begins.

6. The method of claim 1, further comprising:
transmitting the applicant presentation information from the server to a computer associated with a first applicant and to a computer associated with a second applicant;
receiving first applicant response information at the server from the computer associated with the first applicant, wherein the first applicant response information includes first audio information recorded in response to an interaction with the record icon;
receiving second applicant response information at the server from the computer associated with the second applicant, wherein the second applicant response information includes second audio information recorded in response to an interaction with the record icon;
storing the first audio information and the second audio information in the at least one memory;
transmitting the administrator presentation information from the server to a computer associated with an administrator, wherein the administrator presentation information includes information identifying the first applicant, information identifying the second applicant, the at least one question, a play icon associated with the at least one question and the first applicant, a play icon associated with the at least one question and the second applicant, the first audio information, and the second audio information.

7. The method of claim 6, wherein:
the applicant presentation information transmitted to the computer associated with the first applicant includes a request for a resume of the first applicant;
the applicant presentation information transmitted to the computer associated with the second applicant includes a request for a resume of the second applicant;
the first applicant response information includes the resume of the first applicant;
the second applicant response information includes the resume of the second applicant;
the resume of the first applicant and the resume of the second applicant are stored in the at least one memory; and
the administrator presentation information includes the resume of the first applicant and the resume of the second applicant.

8. A system for evaluating an applicant for a job, wherein the system comprises:
at least one processor;
at least one memory including a set of instructions that, when executed by the at least one processor, cause the at least one processor to perform operations including:
causing transmission of applicant presentation information to a computer associated with an applicant, wherein the applicant presentation information includes at least one question and a record icon associated with the at least one question;
receiving applicant response information from the computer associated with the applicant, wherein the applicant response information includes audio information recorded in response to an interaction with the record icon;
storing the audio information in the at least one memory;
causing transmission of administrator presentation information to a computer associated with an administrator, wherein the administrator presentation information includes information identifying the applicant, the at least one question, a play icon associated with the at least one question, and the audio information.

9. The system of claim 8, wherein:
the applicant presentation information includes a request for a resume of the applicant; and
the applicant response information includes the resume of the applicant.

10. The system of claim 8, wherein the applicant response information does not include video information.

11. The system of claim 8, wherein:
the applicant presentation information includes timer information;
the timer information causes a countdown timer to be implemented on the computer associated with the applicant;
the countdown timer begins timing in response to the interaction with the record icon; and
the audio information only includes information recorded during execution of the countdown timer.

12. The system of claim 11, wherein a selected one of the at least one question is caused to be displayed on the computer associated with the applicant only after the countdown timer begins.

13. The system of claim 8, wherein the set of instructions, when executed by the at least one processor, cause the at least one processor to perform operations further including:
causing transmission of the applicant presentation information to a computer associated with a first applicant and to a computer associated with a second applicant;
receiving first applicant response information from the computer associated with the first applicant, wherein the first applicant response information includes first audio information recorded in response to an interaction with the record icon;
receiving second applicant response information from the computer associated with the second applicant, wherein the second applicant response information includes second audio information recorded in response to an interaction with the record icon;
storing the first audio information and the second audio information in the at least one memory; and
causing transmission of the administrator presentation information to a computer associated with the administrator, wherein the administrator presentation information includes information identifying the first applicant, information identifying the second applicant, the at least one question, a play icon associated with the at least one question and the first applicant, a play icon associated with the at least one question and the second applicant, the first audio information, and the second audio information.

14. The system of claim 13, wherein:
the applicant presentation information transmitted to the computer associated with the first applicant includes a request for a resume of the first applicant;
the applicant presentation information transmitted to the computer associated with the second applicant includes a request for a resume of the second applicant;
the first applicant response information includes the resume of the first applicant; and
the second applicant response information includes the resume of the second applicant.

15. At least one non-transitory computer-readable medium including a set of instructions stored thereon that, when executed by at least one processor, cause the at least one processor to perform operations including:
causing transmission of applicant presentation information to a computer associated with an applicant, wherein the applicant presentation information includes at least one question and a record icon associated with the at least one question;
receiving applicant response information from the computer associated with the applicant, wherein the applicant response information includes audio information recorded in response to an interaction with the record icon;
storing the audio information in the at least one memory;
causing transmission of administrator presentation information to a computer associated with an administrator, wherein the administrator presentation information includes information identifying the applicant, the at least one question, a play icon associated with the at least one question, and the audio information.

16. The at least one non-transitory computer-readable medium of claim 15, wherein:
the applicant presentation information includes a request for a resume of the applicant; and
the applicant response information includes the resume of the applicant.

17. The at least one non-transitory computer-readable medium of claim 15, wherein the applicant response information does not include video information.

18. The at least one non-transitory computer-readable medium of claim 15, wherein:
the applicant presentation information includes timer information;
the timer information causes a countdown timer to be implemented on the computer associated with the applicant;
the countdown timer begins timing in response to the interaction with the record icon; and
the audio information only includes information recorded during execution of the countdown timer.

19. The at least one non-transitory computer-readable medium of claim 18, wherein a selected one of the at least one question is caused to be displayed on the computer associated with the applicant only after the countdown timer begins.

20. The at least one non-transitory computer-readable medium of claim 15, wherein the set of instructions, when executed by the at least one processor, cause the at least one processor to perform operations including:
causing transmission of the applicant presentation information to a computer associated with a first applicant and to a computer associated with a second applicant;
receiving first applicant response information from the computer associated with the first applicant, wherein the first applicant response information includes first audio information recorded in response to an interaction with the record icon;
receiving second applicant response information from the computer associated with the second applicant, wherein the second applicant response information includes second audio information recorded in response to an interaction with the record icon;
storing the first audio information and the second audio information in the at least one memory; and
causing transmission of the administrator presentation information to a computer associated with the administrator, wherein the administrator presentation information includes information identifying the first applicant, information identifying the second applicant, the at least one question, a play icon associated with the at least one question and the first applicant, a play icon associated with the at least one question and the second applicant, the first audio information, and the second audio information.

21. The at least one non-transitory computer-readable medium of claim 20, wherein:
the applicant presentation information transmitted to the computer associated with the first applicant includes a request for a resume of the first applicant;
the applicant presentation information transmitted to the computer associated with the second applicant includes a request for a resume of the second applicant;
the first applicant response information includes the resume of the first applicant;
the second applicant response information includes the resume of the second applicant;
the resume of the first applicant and the resume of the second applicant are stored in the at least one memory; and
the administrator presentation information includes the resume of the first applicant and the resume of the second applicant.
